(19) United States
(12) Patent Application Publication
(10) Pub. No.: US 2024/0422804 A1
(43) Pub. Date: Dec. 19, 2024

(54) Managing Point-to-Point and Point-to-Multipoint Communication in a Distributed Base Station

(71) Applicant: GOOGLE LLC, Mountain View, CA (US)

(72) Inventor: Chih-Hsiang Wu, Taoyuan City (TW)

(21) Appl. No.: 18/702,568

(22) PCT Filed: Oct. 18, 2022
(86) PCT No.: PCT/US2022/046939

§ 371 Date: Apr. 18, 2024

Related U.S. Application Data
(60) Provisional application No. 63/271,115, filed on Oct. 22, 2021.

(51) Int. Cl. H04W 72/30; H04W 76/40; H04W 88/08

(52) U.S. Cl. CPC H04W 72/30; H04W 76/40; H04W 88/085

(57) ABSTRACT

A method for managing transmission of MBS is implemented in a CU of a distributed base station that includes the CU and a DU. The method includes receiving from a core network (CN), a request to configure resources for transmitting downlink (DL) MBS data associated with an MBS session; determining, based at least one of (i) a capability of the DU or (ii) a capability of a UE that joined the MBS session, whether the DU should transmit the MBS data to the UE over at least one of a radio interface using a PTP or a PTM delivery mechanism; and causing the DU to transmit the MBS data in accordance with the determined delivery mechanism.

### FIELD OF THE DISCLOSURE

This disclosure relates to wireless communications and, more particularly, to managing multicast and/or broadcast communications in a distributed base station environment.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station, also called a disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR. 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station receives an MBS data packet from a core network and how the base station transmits each MBS data packet to UEs.

### SUMMARY

One example embodiment of the techniques of this disclosure is a method for managing transmission of multicast and/or broadcast services (MBS), implemented in a CU of a distributed base station that includes the CU and a DU. The method includes receiving, by processing hardware from a core network, an MBS data packet for a UE; determining, based at least one of (i) a capability of the DU or (ii) a capability of the UE, whether the DU should transmit the MBS data packet to the UE over a radio interface using a point-to-point (PTP) or a point-to-multipoint (PTM) delivery mechanism; and causing the DU to transmit the MBS data in accordance with the determined delivery mechanism.

Another example embodiment of these techniques is a network node including processing hardware and configured to implement one of the methods above.

### BRIEF DESCRIPTION OF THE DRAWINGS

FIG. 1A is a block diagram of an example wireless communication system in which a Core Network (CN), a base station (BS), and a User Equipment (UE) can implement the techniques of this disclosure for managing Multicast and/or Broadcast Services (MBS) communications in a distributed base station environment;

FIG. 1B is a block diagram of an example base station (BS) including a central unit (CU) and a distributed unit (DU) that can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 2C is a block diagram of another example protocol stack according to which the UE of FIG. 1A can communicate with a DU and a CU of a base station, including support for F1AP protocol between the CU and DU;

FIG. 2D is a block diagram of an example protocol stack according to which a CU and a DU can communicate user-plane traffic;

FIG. 2E is a block diagram of an example protocol stack according to which a CU and a DU can communicate control-plane traffic;

FIG. 3 is a block diagram illustrating example tunnel architectures for MBS sessions and PDU sessions;

FIG. 4 is a block diagram illustrating example MRBs and DRBs which a distributed base station can configure for communicating multicast, broadcast, and/or unicast traffic with UEs;

FIG. 5A is a messaging diagram of an example scenario in which a DU generates a PTP configuration for a certain MBS session and transmits downlink (DL) MBS data to the DU via UE-specific DL tunnels;

FIG. 5B is a messaging diagram of an example scenario in which a DU generates a PTP configuration for a certain MBS session and transmits downlink MBS data to the DU for multiple UEs via a common (group-specific) DL tunnel;

FIG. 6A is a messaging diagram of an example scenario in which a DU generates a PTM configuration for a certain MBS session and transmits downlink MBS data to the DU via a group-specific DL tunnel;

FIG. 6B is a messaging diagram of an example scenario in which a DU generates, for a certain MBS session, a PTP configuration for a set of UE and a PTM configuration for another set of UEs, and transmits downlink MBS data to the DU using UE-specific and group-specific tunnels;

FIG. 6C is a messaging diagram of an example scenario similar that of FIG. 6B, but with the DU also forwarding PDCP control PDUs in the uplink direction;

FIG. 7A is a messaging diagram of an example scenario in which a CU configures, for certain UEs, both PTP and PTM resources for an MBS session;

FIG. 7B is a messaging diagram of an example scenario similar that of FIG. 7A, but a UE also transmitting RCL control PDUs to the DU;

FIG. 8A is a flow diagram of an example method in a CU for determining whether to cause the DU to request PTM or PTP configuration for a UE, depending on whether the UE supports multicast communications;

FIG. 8B is a flow diagram of an example method in a CU for determining whether to cause the DU to request PTM or PTP configuration for a UE, depending on whether the DU supports multicast communications;

FIG. 8C is a flow diagram of an example method in a CU for determining whether to cause the DU to request PTM or PTP configuration for a UE, depending on whether the UE supports multicast communications for MBS;

FIG. 9A is a flow diagram of an example method in a DU for determining whether to generate a PTP or PTM configuration for a UE, depending on whether the UE supports multicast communications;

FIG. 9B is a flow diagram of an example method in a DU for determining whether to generate a PTP or PTM configuration for a UE, depending on whether the UE supports multicast communications for MBS;

FIG. 10A is a flow diagram of an example method in a CU for determining whether to configure a group-specific or one or more UE-specific tunnels, depending on whether the UE(s) support multicast communications;

FIG. 10B is a flow diagram of an example method in a CU for determining whether to configure a group-specific or one or more UE-specific tunnels, depending on whether the DU supports multicast communications;

FIG. 11A is a flow diagram of an example method in a DU for determining whether to include a group identifier such as a G-RNTI in a DU configuration, depending on whether the CU requested multicast configuration parameters for an MBS session;

FIG. 11B is a flow diagram of an example method in a DU for determining whether to include a group identifier such as a G-RNTI in a DU configuration related to a UE, depending on whether the UE supports multicast configuration;

FIG. 11C is a flow diagram of an example method in a DU for determining whether to include a group identifier such as a G-RNTI in a DU configuration, depending on whether the DU supports multicast communications;

FIG. 12A is a flow diagram of an example method in a DU for determining whether to include a G-RNTI or a unicast configuration in a DU configuration, depending on whether the CU requested multicast configuration parameters for an MBS session;

FIG. 12B is a flow diagram of an example method in a DU for determining whether to include a G-RNTI or a unicast configuration in a DU configuration related to a UE, depending on whether the UE supports multicast configuration;

FIG. 12C is a flow diagram of an example method in a DU for determining whether to include a G-RNTI or a unicast configuration in a DU configuration related to a UE, depending on whether the DU supports multicast communications;

FIG. 13 is a flow diagram of an example method in a DU for determining whether the DU should generate a configuration for an MBS session, depending on whether the DU previously configured the MBS session;

FIG. 14A is a flow diagram of an example method in a UE for configuring PTP reception of MBS data;

FIG. 14B is a flow diagram of an example method in a UE for configuring PTP reception of MBS data, without explicitly indicating PTP support to the RAN;

FIG. 15 is a flow diagram of an example method in a UE for indicating capabilities related to MBS, to the RAN and/or the CN; and

FIG. 16 is a flow diagram of an example method in a UE for determining how the UE should report multicast and unicast capabilities to the RAN and/or the CN.

### DETAILED DESCRIPTION OF THE DRAWINGS

As discussed in more detail below, the nodes of a distributed base station of this disclosure manage MBS transmissions at the CU-to-DU interface as well as the radio interface between one or more DUs and multiple UEs that joined an MBS session. More specifically, the CU can configure a common DL tunnel on the CU-to-DU link, for transmitting MBS data packets received from a CN to the multiple UEs. The one or more DUs can configure logical channels (e.g., MTCHs, DTCHs) on the radio interface for the MBS session. The CU can further configure a multicast radio bearer (MRB) that includes a DL tunnel on the CU-to-DU link, optionally an UL tunnel on the CU-to-DU link, one or more DL logical channels, and optionally one or more uplink logical channels. Still further, the CU in some cases can configure multiple QoS flows of an MBS session, which the DU can map to respective different logical channels.

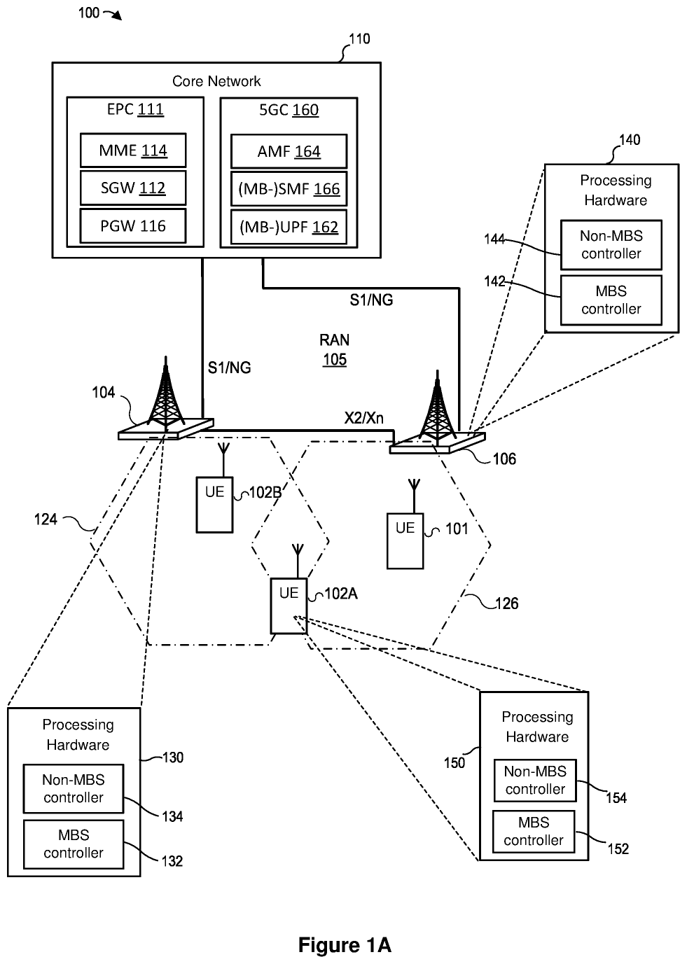

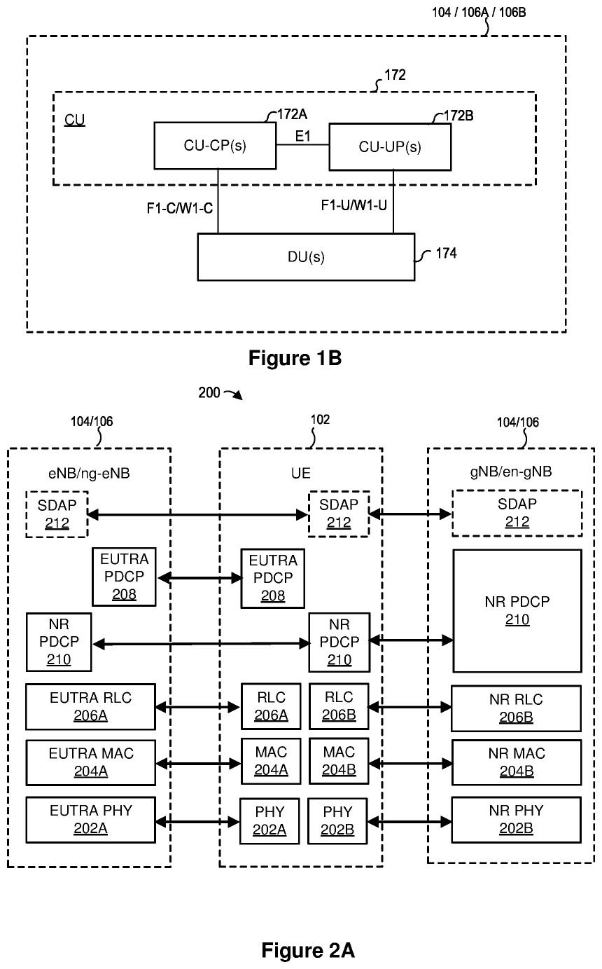

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 can include a user plane function (UPF) 162 and an access and mobility management function (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast services and MBS services, or for MBS services only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

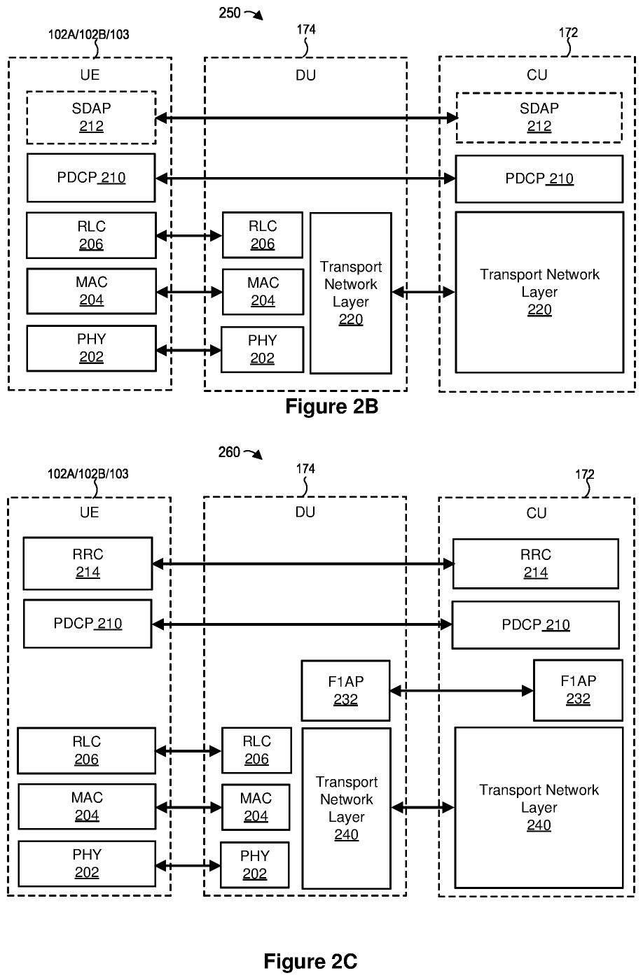

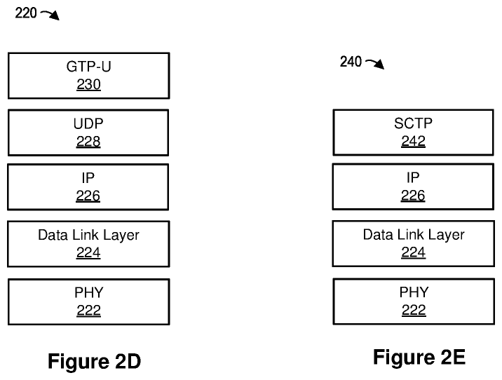

FIG. 2A illustrates, in a simplified manner, an example protocol stack 200 according to which a UE (e.g., UE 102A or 102B) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A or 102B, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A or 102B can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A or 102B receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A or 102B uses PHY sublayer 202, MAC sublayer 204, and RLC sublayer 206 to receive the MBS data packets. In such implementations, the base station and the UE 102A or 102B may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A of 102B uses PHY sublayer 202, MAC sublayer 204, RLC sublayer 206 and PDCP sublayer 208 to receive the MBS data packets. In such implementations, the base station and the UE 102A or 102B may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A or 102B uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE 102A or 102B can use to communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

FIG. 2C illustrates, in a simplified manner, an example protocol stack 260 which the UE 102A or 102B can use to communicate with a DU (e.g., DU 174) and a CU (e.g., CU 172). The protocol stack 260 is generally similar to the protocol stack 250, but here the RRC layer 214 is layered over the PDCP layer 210 to convey RRC messages between a UE and the CU 172, transparently to the DU 174.

FIG. 2D is a block diagram of an example protocol stack 270 according to which the CU 172 and a DU 174 can communicate user-plane traffic. A GTP-U layer 278 is layered over UDP 276, in turn layered over IP 274. The UDP/IP layers reside over a data link layer 272 and a PHY 271 layer. The PHY layer 271 can be a wired link, for example.

FIG. 2E is a block diagram of an example protocol stack 280 according to the CU 172 and a DU 174 can communicate control-plane traffic. The stack 280 is generally similar to the stack 270, but here a Stream Control Transmission Protocol (SCTP) layer 282 resides over the IP layer 274 to convey control messages.

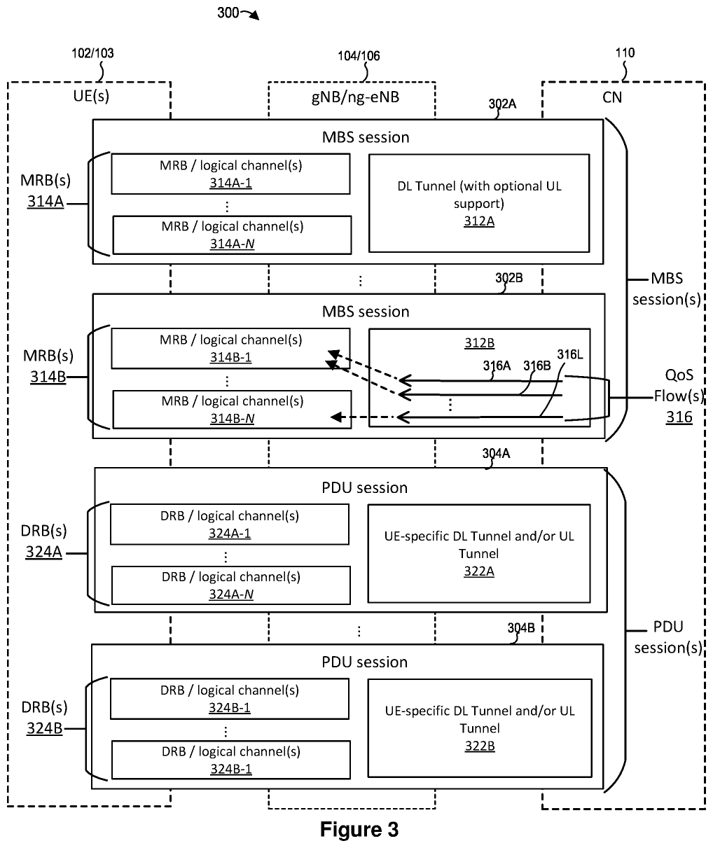

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A. 316B . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324A-N. Each of the DRBs 324A can correspond to a respective logical channel, such as a Dedicated Traffic Channel (DTCH). The base station 104/106 and the CN 110 can also maintain one or more other PDU sessions to support unicast traffic between the CN 110 and particular UEs. For example, PDU session 304B can include a UE-specific DL tunnel and/or UE-specific UL tunnel 322B corresponding to one or more DRBs 324B, such as a DRB 324B-1, 324B-2 . . . 324B-N. Each of the DRBs 324B can correspond to a respective logical channel, such as a DTCH.

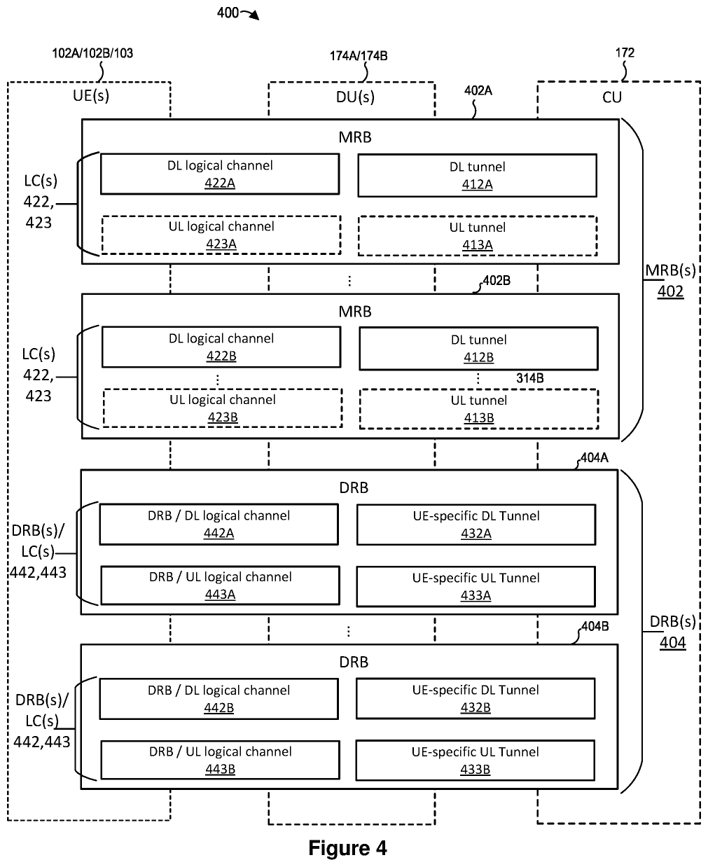

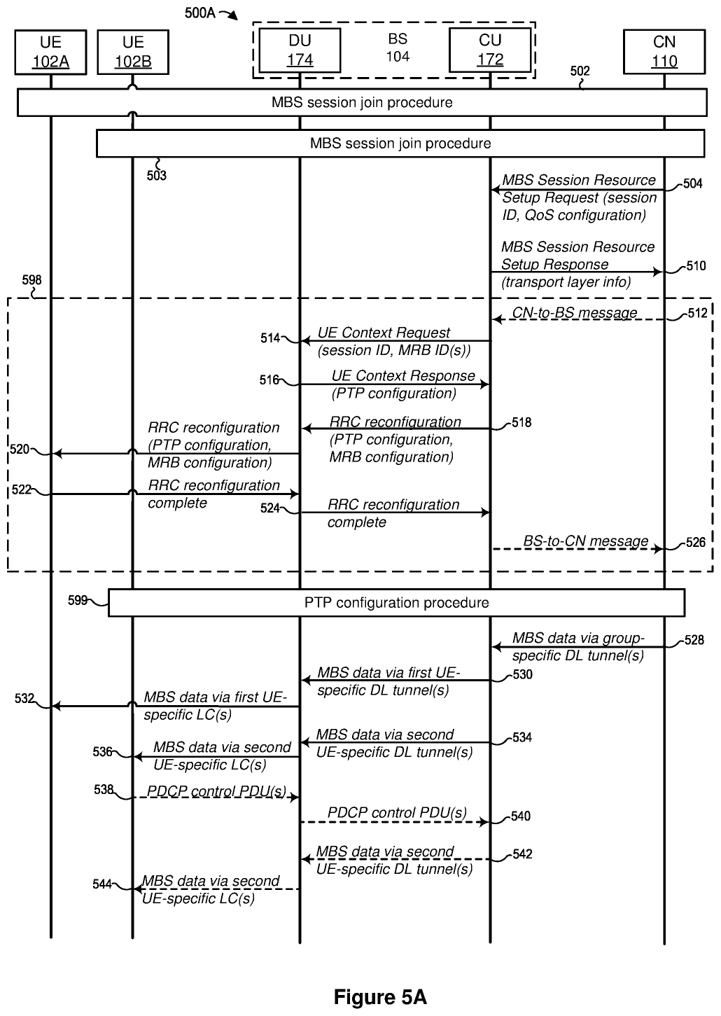

Now referring to FIG. 4, when the base station 104/106 is implemented in a distributed manner, one or more DUs 174A/174B can be associated with the CU 172. The CU 172 and the DU(s) 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU(s) 174A/174B, and a DL logical channel 422A corresponding to the DL tunnel 412A. In particular, the DU(s) 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU(s) 174A/174B, and a UL logical channel 423A corresponding to the UL tunnel 413A. The UL logical channel 423A can be a DTCH, for example. The DU(s) 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU(s) 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU(s) 174A/174B, and a DL logical channel 442A corresponding to the DL tunnel 432A. In particular, the DU(s) 174A/174B can map downlink traffic received via the DL tunnel 432A to the DL logical channel 442A, which can be a DTCH, for example. The DRB 404A further includes a UE-specific UL tunnel 433A connecting the CU 172 and the DU(s) 174A/174B, and a UL logical channel 443A corresponding to the UL tunnel 433A. The UL logical channel 443A can be a PUSCH, for example. The DU(s) 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

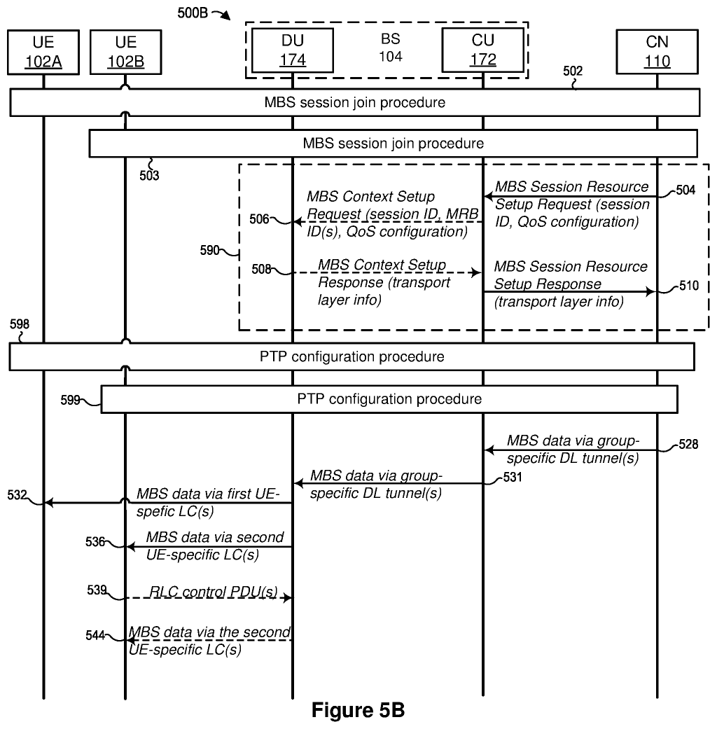

Referring to FIG. 5A, the UE 102A in a scenario 500A initially performs 502 an MBS session join procedure with the CN 110 via the base station 104 to join a certain MBS session. In some scenarios, the UE 102A subsequently performs additional one or more MBS join procedures, and event 502 accordingly is a first one of multiple MBS join procedures. When the base station 104 configures a common DL tunnel for MBS traffic rather than a UE-specific tunnel, the procedures 502 and 586 can occur in either order. In other words, the base station 104 can configure a common DL tunnel before even a single UE joins the MBS session.

To perform the MBS session join procedure (event 502), the UE 102A in some implementations sends an MBS session join request message to the CN 110 via the base station 104. In response, the CN 110 can send an MBS session join response message to the UE 102A via the base station 104 to grant the UE 102A access to the first MBS session. In some implementations, the UE 102A can include an MBS session ID of the MBS session in the MBS session join request message. The CN 110 in some cases includes the MBS session ID in the MBS session join response message. In some implementations, the UE 102A can send an MBS session join complete message to the CN 110 via the base station 104 in response to the MBS session join response message.

The UE 102A in some cases performs additional MBS session join procedure(s) with the CN 110 via the RAN 105 (e.g., the base station 104 or base station 106) to join additional MBS session(s). For example, the UE 102A can perform a second MBS session join procedure with the CN 110 via the RAN 105 to join a second MBS session. Similar to event 502, the UE 102A in some implementations can send a second MBS session join request message to the CN 110 via the base station 104, and the CN 110 can respond with a second MBS session join response message to grant the UE 102A access to the second MBS session. In some implementations, the UE 102A can send a second MBS session join complete message to the CN 110 via the base station 104 in response to the second MBS session join response message. In some implementations, the UE 102A can include a second MBS session ID of the second MBS session in the second MBS session join request message. The CN 110 optionally includes the second MBS session ID in the second MBS session join response message. In some implementations, the UE 102A can include the first and second MBS session IDs in an MBS session join request message (e.g., the first MBS session join request message) to request to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management (5GSM) messages. In the case of the 5GSM messages, the UE 102A can transmit to the CN 110 via the base station 104 a (first) UL container message including the MBS session join request message, the CN 110 can transmit to the UE 102A via the base station 104 a DL container message including the MBS session join response message, and the UE 102A can transmit to the CN 110 via the base station 104 a (second) UL container message including the MBS session join complete message. These container messages can alternatively be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can also represent their respective container messages.

In some implementations, the UE 102A can perform (not shown) a PDU session establishment procedure with the CN 110 via the base station 104 to establish a PDU session in order to perform the (first) MBS session join procedure. During the PDU session establishment procedure, the UE 102A can communicate a PDU session ID of the PDU session with the CN 110 via the base station 104.

Similar to event 502, the UE 102B performs 503 a second MBS session join procedure with the CN 110. To this end, the UE 102B, base station 104, and the CN 110 can exchange message similar to those discussed above with reference to event 502.

Before, during or after the first MBS session join procedure, the CN 110 can send 504 a first CN-to-BS message including the first MBS session ID to the CU 172 to request the CU 172 to configure resources for the first MBS session. In some implementations, the CN 110 can additionally include quality of service (QOS) configuration(s) for the first MBS session in the first CN-to-BS message. In response to the first CN-to-BS message, the CU 172 can send 510 to the CN 110 a first BS-to-CN message (e.g., MBS Session Resource Setup Response message) including a CU DL transport layer configuration to configure a group-specific CN-to-BS DL tunnel for the first MBS session. In some implementations, the first CN-to-BS message can be an existing NGAP message or a new NGAP message (e.g., MBS Session Resource Setup Request message). In some implementations, the first BS-to-CN message can be an existing NGAP message or a new NGAP message (e.g., MBS Session Resource Setup Response message). The CU DL transport layer configuration includes a first CU DL transport layer address (e.g., an Internet Protocol (IP) address) and a first CU DL TEID to identify the CN-to-BS common DL tunnel.

In some implementations, the QoS configuration(s) include QoS parameters for the first MBS session. In some implementations, the QoS configuration includes configuration parameters to configure one or more QoS flows for the first MBS session. In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5Q1), a priority level, packet delay budget, packet error rate, averaging window and/or a maximum data burst volume. The CN 110 can set different values of the QoS parameters for the QoS flows.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CU 172 can send 526 a second BS-to-CN message to the CN 110 in response to the second CN-to-BS message 512. In such cases, the second CN-to-BS message can be a non-UE-associated message, i.e., not specific for the UE 102A. For example, the list of UEs includes the UE 102A and/or UE 102B. To indicate a list of UEs, the CN 110 can include a list of (CN UE interface ID, RAN UE interface ID) pairs each identifying a particular UE of the UEs. The CN 110 assigns the CN UE interface ID and the base station 104 assigns the RAN UE interface ID. Before the CN 110 sends the list of (CN UE interface ID, RAN UE interface ID) pairs, the base station 104 sends a BS-to-CN message (e.g., a NGAP message, an INITIAL UE MESSAGE message or PATH SWITCH REQUEST message) including the RAN UE interface ID to the CN 110 for each of the UEs, and the CN 110 sends a CN-to-BS message (e.g., a NGAP message, an INITIAL CONTEXT SETUP REQUEST message or PATH SWITCH REQUEST ACKNOWLEDGE message) including the CN UE interface ID to the base station 104 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID”. In other implementations, the CN 110 can include a list of UE IDs each identifying a particular UE of the UEs. In some implementations, the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends the list of UE IDs, the CU 172 can receive the UE ID from the UE 102 or the CN 110 for each of the UEs. For example, the CU 172 can receive an RRC message (e.g., a RRCSetupComplete message) including the UE ID from the UE 102 during an RRC connection establishment procedure. In another example, the CU 172 can receive a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102A joins the first MBS session. The second CN-to-BS message can be a UE-associated message for the UE 102A. That is, the second CN-to-BS message is specific for the UE 102A. After or in response to receiving the second CN-to-BS message, the CU 172 can send 514 to the DU 174 a UE Context Request message for the UE 102A. In some implementations, the CU 172 can include, in the UE Context Request message, the first MBS session ID and/or MRB ID(s) of MRB(s) associated to the first MBS session (ID). In some implementations, the CU 172 can include the QoS configuration(s) in the UE Context Request message. In such cases, the CU 172 may or may not include the QoS configuration(s) in the CU-to-DU message. In response to the UE Context Request message, the DU 174 sends 516 to the CU 172 a UE Context Response message including PTP configuration parameters for the UE 102A to receive MBS data of the first MBS session. (Some of) the PTP configuration parameters may be associated to the MRB(s)/MRB ID(s). In some implementations, the DU 174 generates a DU configuration to include the PTP configuration parameters and include the DU configuration in the UE Context Response message. In some implementations, the DU configuration can be a CellGroupConfig IE. In other implementations, the DU configuration can be an MBS specific IE. In some implementations, the PTP configuration parameters include at least one first logical channel.

In some implementations, the DU 174 includes DU DL transport layer configuration(s) in the UE Context Response message to configure first UE-specific DL tunnel(s) for the UE 102A. Each of the DU DL transport layer configuration(s) includes a DU transport layer address (e.g., an Internet Protocol (IP) address) and a DU DL tunnel ID (TEID) to identify the CU-to-DU common DL tunnel. The DU 174 can configure different DU transport layer addresses and/or different DU DL TEIDs for the UE-specific DL tunnels. In some implementations, the CU 172 can include a CU UL transport layer configuration in the UE Context Request message to configure a UE-specific UL tunnel. The CU 172 can include a CU transport layer address (e.g., an IP address) and a CU UL TEID in the CU UL transport layer configuration to identify the UE-specific UL tunnel.

In some implementations, the CU 172 can indicate the DU 174 to generate PTP configuration parameters for the UE 102A in the UE Context Request message. For example, the CU 172 can include a PTP indication in the UE Context Request message. In another example, the CU 172 can exclude a PTM indication in the UE Context Request message in order to indicate the DU 174 to generate PTP configuration parameters. In some implementations, the CU 172 indicates the DU 174 to generate PTP configuration parameters if the CU 172 determines the UE 102A does not support PTM communication, i.e., the UE 102A does not support reception of PTM transmission. In some implementations, the CU 172 indicates the DU 174 to generate PTP configuration parameters if the CU 172 determines the UE 102A supports PTP communication, i.e., the UE 102A supports reception of PTP transmission. Before or during the first MBS session join procedure, the CU 172 can receive UE capabilities of the UE 102A from the UE 102A, another base station (e.g., the base station 106), another CU (e.g., a CU of the base station 106) or the CN 110 (e.g., AMF 164). For example, the CU 172 can receive a UE Capability IE including the UE capabilities from the UE 102A, another base station (e.g., the base station 106), another CU (e.g., a CU of the base station 106) or the CN 110 (e.g., AMF 164). For example, the UE Capability IE can be a UE-NR-Capability IE or a UE-6G-Capability IE. The UE capabilities indicates whether the UE 102A supports PTM or PTP communication. Thus, the CU 172 can determine whether the UE 102A supports PTM or PTP communication based on the UE capabilities.

In some implementations, the CU 172 indicates the DU 174 to generate PTP configuration parameters if the CU 172 determines the DU 174 does not support PTM communication, i.e., the DU 174 does not support reception of PTM transmission. In some implementations, the CU 172 indicates the DU 174 to generate PTP configuration parameters if the CU 172 determines the DU 174 supports PTP communication, i.e., the DU 174 supports reception of PTP transmission. Before or during the first MBS session join procedure, the CU 172 in some implementations can receive DU capabilities of the DI 174 from the DU 174, the CN 110 (e.g., AMF 164) or an Operations, Administration and Maintenance (OAM) node. For example, the CU 172 can receive a DU Capability IE including the DU capabilities from the DU 174, the CN 110 (e.g., AMF 164) or the OAM node. For example, the DU Capability IE can be a DU-NR-Capability IE or a DU-6G-Capability IE. The UE capabilities indicates whether the UE 102A supports PTM or PTP communication. Thus, the CU 172 can determine whether the DU 174 supports PTM or PTP communication based on the DU capabilities. In other implementations, the CU 172 can determine whether the DU 174 supports PTP or PTM communication based on a pre-configuration. For example, the CU 172 can be pre-configured to determine that the DU 174 supports PTP communication. In another example, the CU 172 can be pre-configured to determine that the DU 174 does not support PTP communication. In yet another example, the CU 172 can be pre-configured to determine that the DU 174 supports PTM communication. In an additional example, the CU 172 can be pre-configured to determine that the DU 174 does not support PTM communication.

In some implementations, the UE Context Request message and the UE Context Response message can be a UE Context Setup Request message and a UE Context Setup Response message, respectively. In other implementations, the UE Context Request message and the UE Context Response message can be a UE Context Modification Request message and a UE Context Modification Response message, respectively.

After receiving 516 the UE Context Response message, the CU 172 generates an RRC reconfiguration message including the PTP configuration parameters and one or more MRB configurations and transmits 518 the RRC reconfiguration message to the DU 174. In turn, the DU 174 transmits 520 the RRC reconfiguration message to the UE 102A. In response, the UE 102A transmits 522 an RRC reconfiguration complete message to the DU 174, which in turn sends 523 the RRC reconfiguration complete message to the CU 172.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B and PHY layer 202B. The UE 102A receives 520 the PDCP PDU from the DU 174 via the PHY layer 202B, MAC layer 204B and RLC layer 206B. In some implementations, the UE 102A generates a PDCP PDU including the RRC reconfiguration complete message and transmits 522 the PDCP PDU to the DU 174 via the RLC layer 206B, MAC layer 204B and PHY layer 202B. The DU 174 receives 522 the PDCP PDU from the UE 102 via the PHY layer 202B, MAC layer 204B and RLC layer 206B and sends 523 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 526 a second BS-to-CN message to the CN 110 in response to the second CN-to-BS message 408. The CN 110 can include the PDU Session Modification Command message or the second DL container message for the UE 102A in the second CN-to-BS message. The CU 172 can include the first CN UE interface ID and the first RAN UE interface ID in the second BS-to-CN message. Alternatively, the CU 172 can include the first UE ID in the second BS-to-BS message.

The events 512, 514, 516, 518, 520, 522, 524 and 526 are collectively referred to in FIG. 5 as a PTP configuration procedure 598.

Similarly, the CN 110, CU 172, DU 174 and UE 102B can perform 599 the PTP configuration procedure, similar to the event 598. In some implementations, the DU 174 includes DU DL transport layer configuration(s) in a UE Context Response message of the PTP configuration procedure 599 to configure second UE-specific DL tunnel(s) and at least one second logical channel for the UE 102B. In some implementations, (some of) the PTP configuration parameters for the UE 102A and the UE 102B to receive MBS data of the first MBS session are the same, i.e., identical. In other implementations, (some of) the PTP configuration parameters for the UE 102A and the UE 102B to receive MBS data of the first MBS session are different.

In some implementations, the CU 172 can include the CU DL transport layer configuration(s) in the second BS-to-CN message for the UE 102A and in the second BS-to-CN message for the UE 102B. In other words, the CU 172 can send the same CU DL transport layer configuration(s) in BS-to-CN messages in responses to CN-to-BS messages indicating UEs joining the same MBS session. In such implementations, the CN 110 can omit the MBS resource setup procedure 504, 510.

After performing 588, 589 the PTP configuration procedures with the UE 102A and the UE 102B, the CN 110 can send 528 MBS data (e.g., one or multiple MBS data packets) to the CU 172 via the group-specific CN-to-BS DL tunnel. The CU 172 can send 530 the MBS data via the first UE-specific tunnel(s) to the DU 174, which in turn transmits (i.e., unicasts) 532 the MBS data via the first logical channel(s) to the UE 102A. Similarly, the CU 172 can send 534 the MBS data via the second UE-specific tunnel(s) to the DU 174, which in turn transmits (i.e., unicast) 536 the MBS data the second logical channel(s) to the UE 102B. In some implementations, the DU 174 can configure the same LCID(s) for first and second logical channel(s) because the DU 174 transmit 532 the MBS data and 536 the MBS data on different radio resources. In other implementations, the DU 174 can configure different LCID(s) for the first and second logical channel(s). For example, the DU 174 configures a first LCID (value) for the first logical channel. The DU 174 has configured the first LCID (value) for a DRB of the UE 102B and the DU 174 can configure a second LCID (value) for the second logical channel. The second LCID (value) is different from the first LCID (value).

In some implementations, the UE 102B can transmit 538, 540 one or more PDCP Control PDU(s) to the CU 172 via DU 174 to request the CU 172 to retransmit one or more MBS data packets that the CU 172 transmits at event 536. In such cases, the CU 172 retransmits 542, the one or more MBS data packets via the second UE-specific DL tunnel(s) to the DU 174, which in turn (re) transmits 544 the one or more MBS data packets to the UE 102B via the second UE-specific logical channel(s). In some implementations, the PDCP Control PDU can include a COUNT value of a first missing MBS data packet and a bitmap indicating one or more missing MBS data packets following the first missing MBS data packet.

In some implementations, the one or more MRB configurations configuring one or more MRBs associated with the first MBS session. In some implementations, the PTP configuration parameters can also include one or more RLC bearer configurations each is associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring configure the logical channel. In some implementations, the RLC bearer configuration may include the MRB ID.

In some implementations, the CU 172 can configure the MRB as a DL only RB in the MRB configuration. For example, the CU 172 refrains from including UL configuration parameters in the PDCP configuration in the MRB configuration to configure the MRB as a DL only RB. The CU 172 only includes DL configuration parameters in the MRB configuration, e.g., as described above. In such cases, the CU 172 configures the UE 102A not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102A not to transmit control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de) compression protocol (e.g., robust header compression (ROHC) protocol), e.g., in the MRB configuration. In this case, when the CU 172 receives 528 an MBS data packet from the CN 110, the CU 172 compresses the MBS data packet with the compression protocol to obtain a compressed MBS data packet and transmits 530 a PDCP PDU including the compressed MBS data packet to the DU 174 via the first UE-specific DL tunnel. In turn, the DU 174 transmits (i.e., unicast) 532 the PDCP PDU to the UE 102A via the first logical channel. When the UE 102A receives the PDCP PDU via the first logical channel, the UE 102A retrieves the compressed MBS data packet from the PDCP PDU. The UE 102A decompressed the compressed MBS data packet with the (de) compression protocol to obtain the original MBS data packet. In such cases, the UE 102A may transmit a PDCP Control PDU including, a header compression protocol feedback (e.g., interspersed ROHC feedback) for operation of the header (de) compression protocol to the DU 174, e.g., via the first logical channel. In turn, the DU 174 sends the PDCP Control PDU to the CU 172 via the (first) UE-specific UL tunnel for the UE 102A.

In some implementations, the CU 172 transmits 534 the PDCP PDU to the DU 174 via the second UE-specific DL tunnel. In turn, the DU 174 transmits (i.e., unicast) 536 the PDCP PDU to the UE 102B via the second logical channel. When the UE 102B receives the PDCP PDU via the second logical channel, the UE 102B retrieves the compressed MBS data packet from the PDCP PDU. The UE 102B decompressed the compressed MBS data packet with the (de) compression protocol to obtain the original MBS data packet. In such cases, the UE 102B may transmit a PDCP Control PDU including, a header compression protocol feedback (e.g., interspersed ROHC feedback) for operation of the header (de) compression protocol to the DU 174, e.g., via the second logical channel. In turn, the DU 174 sends the PDCP Control PDU to the CU 172 via the (second) UE-specific UL tunnel for the UE 102B. In other implementations, when the CU 172 receives 528 an MBS data packet from the CN 110, the CU 172 compresses the MBS data packet with the compression protocol to obtain a second compressed MBS data packet and transmits 534 a second PDCP PDU including the second compressed MBS data packet to the DU 174 via the second UE-specific DL tunnel. In turn, the DU 174 transmits (i.e., unicast) 536 the second PDCP PDU to the UE 102B via the second logical channel. When the UE 102B receives the second PDCP PDU via the second logical channel, the UE 102B retrieves the second compressed MBS data packet from the second PDCP PDU. The UE 102B decompressed the second compressed MBS data packet with the (de) compression protocol to obtain the original MBS data packet. In such cases, the UE 102B may transmit a PDCP Control PDU including, a header compression protocol feedback (e.g., interspersed ROHC feedback) for operation of the header (de) compression protocol to the DU 174, e.g., via the second logical channel. In turn, the DU 174 sends the PDCP Control PDU to the CU 172 via the (second) UE-specific UL tunnel for the UE 102B.

In some implementations, the MRB configuration can be an MRB-ToAddMod IE. A MRB ID identifies a particular MRB of the MRB(s). The base station 104 set the MRB IDs to different values. In cases where the CU 172 has configured DRB(s) to the UE 102 for unicast data communication, the CU 172 in some implementations can set the MRB ID(s) to values different from DRB ID(s) of the DRB(s). In such cases, the UE 102 and the CU 172 can distinguish an RB is a MRB or DRB in accordance an RB ID of the RB. In other implementations, the CU 172 can set the MRB ID(s) to values which can be the same as the DRB ID(s). In such cases, the UE 102 and the CU 172 can distinguish an RB is a MRB or DRB in accordance an RB ID of the RB and an RRC IE configuring the RB. For example, a DRB configuration configuring a DRB is a DRB-ToAddMod IE including a DRB identity and a PDCP configuration. Thus, the UE 102 can determine an RB is an DRB if the UE 102 receives a DRB-ToAddMod IE configuring the RB, and determine an RB is a MRB if the UE 102 receives an MRB-ToAddMod IE configuring the RB. Similarly, the CU 172 can determine an RB is an DRB if the CU 172 transmits a DRB-ToAddMod IE configuring the RB to the UE 102, and determine an RB is a MRB if the CU 172 transmits an MRB-ToAddMod IE configuring the RB to the UE 102.

In some implementations, the configuration parameters for receiving MBS data of the first MBS session include one or more logical channel (LC) ID to configure one or more logical channels. In some implementations, the logical channel(s) can be dedicated traffic channel(s). In some implementations, the logical channel(s) can be dedicated traffic channel(s) (DTCH(s)). In other implementations, the logical channel(s) can be multicast traffic channel(s) (MTCH(s)). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the PDU Session Modification Command message or the second DL container message in the RRC reconfiguration message. The UE 102 can include the PDU Session Modification Complete message or the additional UL container message in the RRC reconfiguration complete message. Alternatively, the UE 102 can send a UL RRC message including the PDU Session Modification Complete message or the additional UL container message to the CU 172 via the DU 174. The UL RRC message can be a ULInformationTransfer message or any suitable RRC message that can include a UL NAS PDU. The CU 172 can include the PDU Session Modification Complete message or the additional UL container message in the second BS-to-CN message. Alternatively, the CU 172 can send to the CN 110 a BS-to-CN message (e.g., an UPLINK NAS TRANSPORT message) including the PDU Session Modification Complete message or the additional UL container message.

In other implementations, the CU 172 transmits a DL RRC message that includes the PDU Session Modification Command message to the UE 102. The DL RRC message can be a DLInformationTransfer message, another RRC reconfiguration message, or any suitable RRC message that can include a DL NAS PDU. The UE 102 can send a UL RRC message including the PDU Session Modification Complete message to the CU 172 via the DU 174. The UL RRC message can be a ULInformationTransfer message, another RRC reconfiguration complete message or any suitable RRC message that can include a UL NAS PDU.

In some implementations, the MBS data includes IP packets, TCP/IP packets, UDP/IP packets, Real-Time Transport Protocol (RTP)/UDP/IP packets or RTP/TCP/IP packets.

Now referring to FIG. 5B, a scenario 500B is generally similar to the scenario 500A, but here, after the CN 110 sends 504 a (first) CN-to-BS message to the CU 172, the CU 172 sends 506 a CU-to-DU message to the DU 174 to request a set-up for an MBS context and/or a common DL tunnel for the first MBS session. In response to receiving 506 the CU-to-DU message, the DU 174 sends 508, to the CU 172, a DU-to-CU message including a first DU DL transport layer configuration to configure a common CU-to-DU DL tunnel for the first MBS session (e.g., for a MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QOS) configuration(s) for the first MBS session in the first CN-to-BS message. In such cases, the CU 172 can include the QoS configuration(s) in the CU-to-DU message (event 506).

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5Q1), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS session resource setup procedure 590.

Further, unlike the scenario 500A, here the CU 172 sends 531 MBS data via the one or more group-specific tunnel(s) to the DU 174, which then unicasts 532, 534 the MBS data to the UE 102A and 102B as in the scenario 500A. As a more specific example, the CU can send 531 a single copy of an MBS data packet to the DU 174, and the DU 174 can send 532, 534 this MBS data packet to two or more UEs. Further, in some scenarios, the DU 174 receives an MBS data packet via a group-specific tunnel and sends the MBS data packet to only one UE operating in a cell of the DU 174.

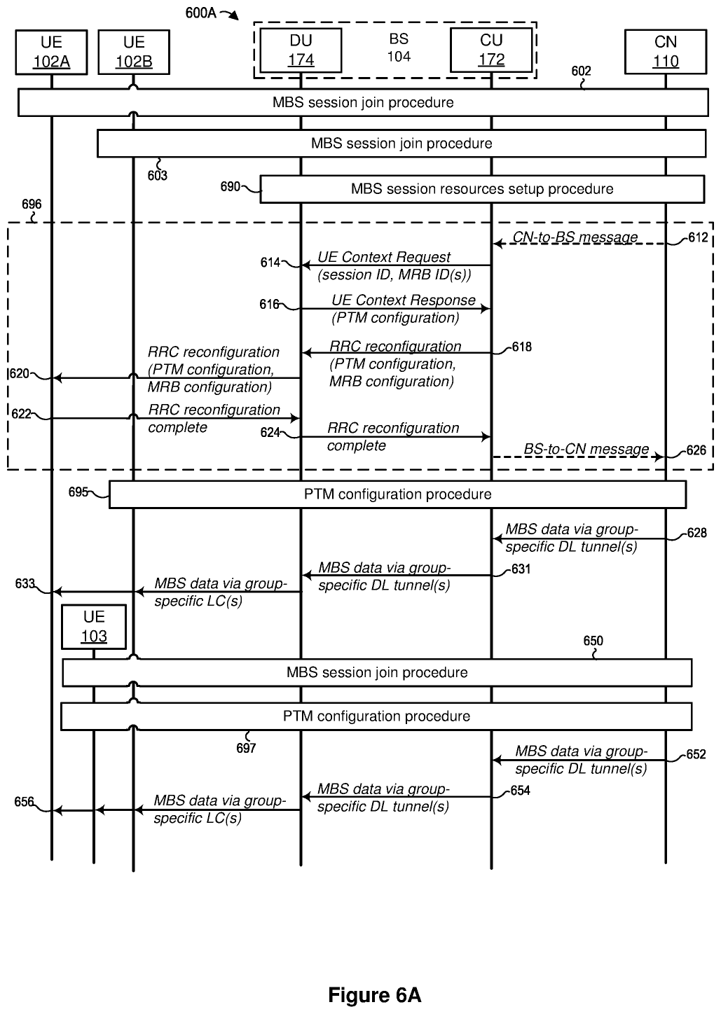

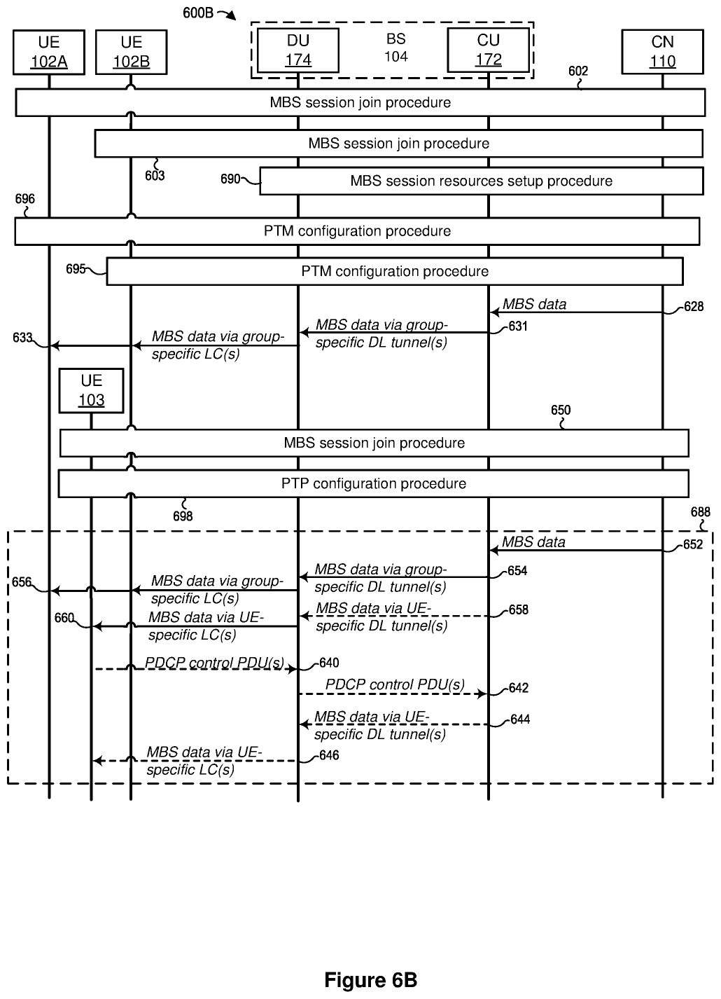

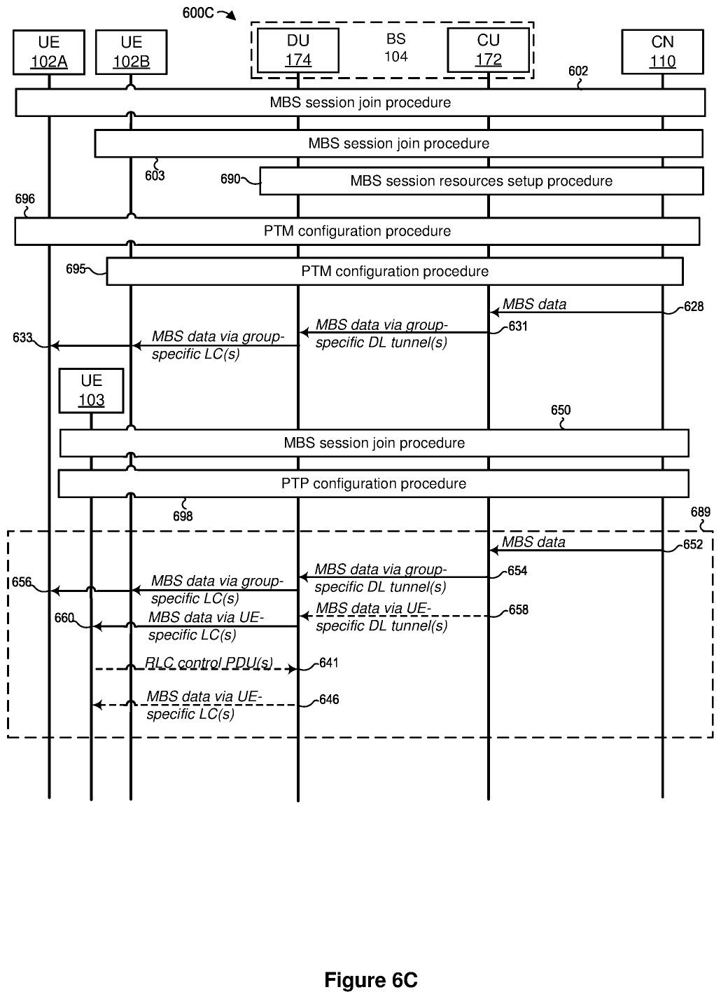

FIG. 6A illustrates an example scenario 600A, in which the UE 102A initially performs 602 an MBS session join procedure with the CN 110 via the base station 104, the UE 10BA similarly performs 603 an MBS session join procedure. The CN 110, the CU 172, and the DU 174 then perform an MBS session resource setup procedure 690. The procedures 602, 603, and 690 are similar to the procedures 502, 503, and 590, respectively.

After the CN 110 sends 612 to the CU 172 a second CN-to-BS message (see the discussion of similar event 512 above), the CU 172 configures at least one MRB for the MBS session and sends 614 to the DU 174 a UE Context Request message including the corresponding MRB ID(s). The DU 174 then generates a PTM configuration for the MBS session and sends 616 a PTM configuration to the CU 172. The CU 172 generates an RRC reconfiguration message including the PTM configuration parameters and one or more MRB configurations and transmits 618 the RRC reconfiguration message to the DU 174. In turn, the DU 174 transmits 620 the RRC reconfiguration message to the UE 102A. In response, the UE 102A transmits 622 an RRC reconfiguration complete message to the DU 174, which in turn sends 624 the RRC reconfiguration complete message to the CU 172. Then, the CU 172 responds 626 to the CN-to-BS message of event 612.

The events 612, 614, 614, 616, 618, 620, 622, 624, and 626 are collectively referred to in FIG. 6 as a PTM configuration procedure 696.

After the UE 102B performs 695 a similar PTM configuration procedure, the CN 110 can send 628 MBS data (e.g., one or multiple MBS data packets) to the CU 172 via the group-specific CN-to-BS DL tunnel, and the CU 172 sends 631 MBS data via the one or more group-specific tunnel(s) to the DU 174, which then uses 633 a group-specific logical channel(s) to multicast the MBS data packets.

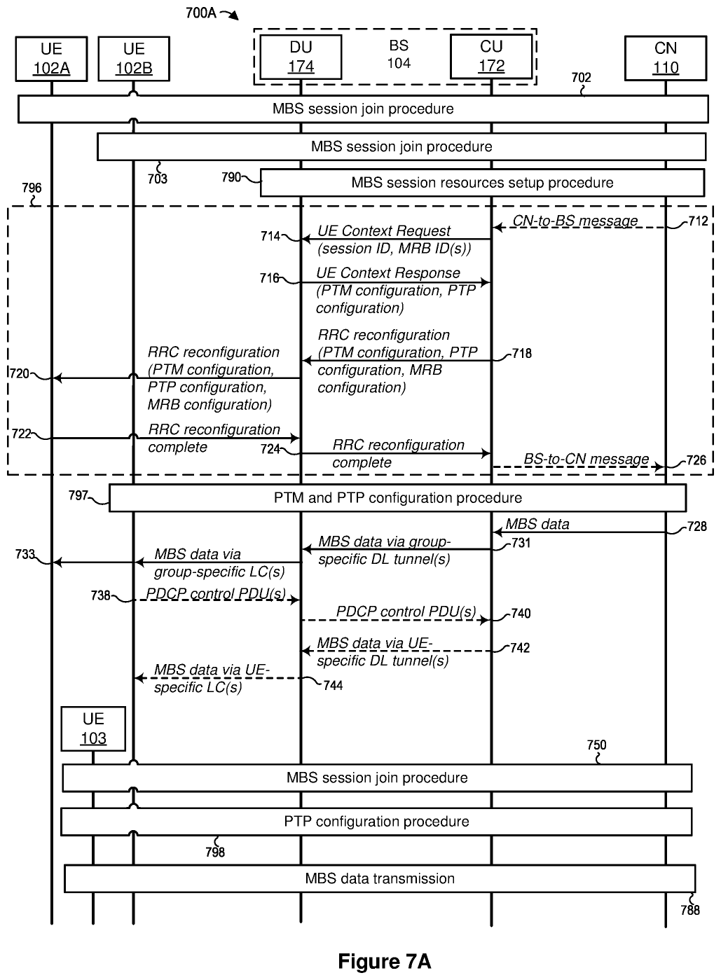

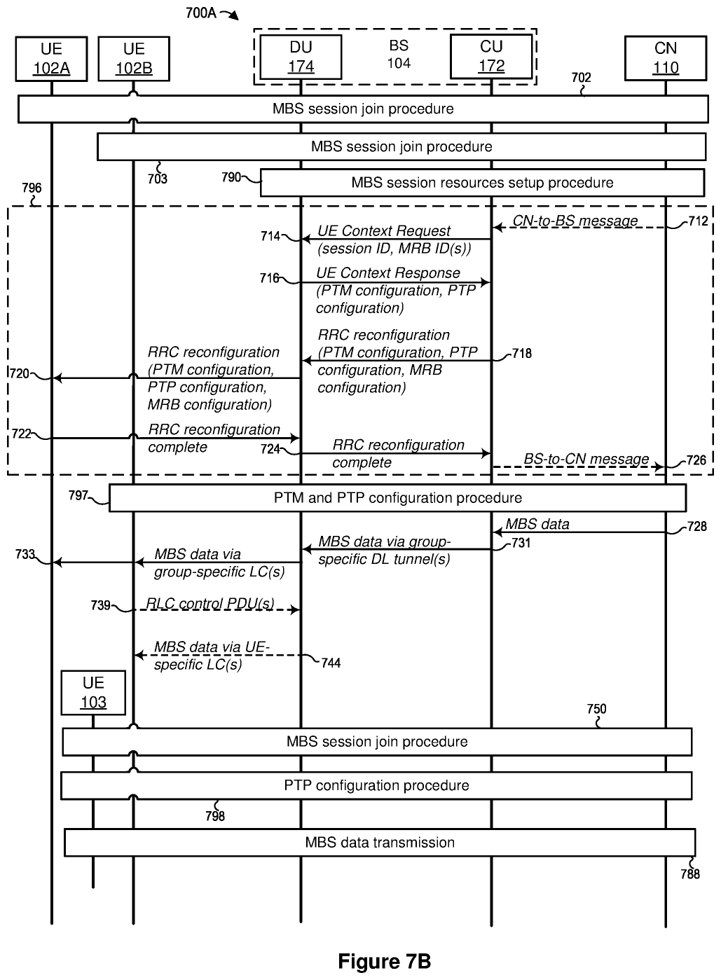

FIG. 6B is a messaging diagram of an example scenario 600 in which a DU generates, a PTP configuration for a set of UE and a PTM configuration for another set of UEs, and transmits downlink MBS data to the DU using UE-specific and group-specific tunnels. FIG. 6C is a messaging diagram 600C of an example scenario similar that of FIG. 6B, but with the DU also forwarding PDCP control PDUs in the uplink direction. FIG. 7A is a messaging diagram of an example scenario 700A in which a CU configures, for certain UEs, both PTP and PTM resources for an MBS session. FIG. 7B is a messaging diagram of an example scenario 700B similar that of FIG. 7A, but a UE also transmitting RCL control PDUs to the D.

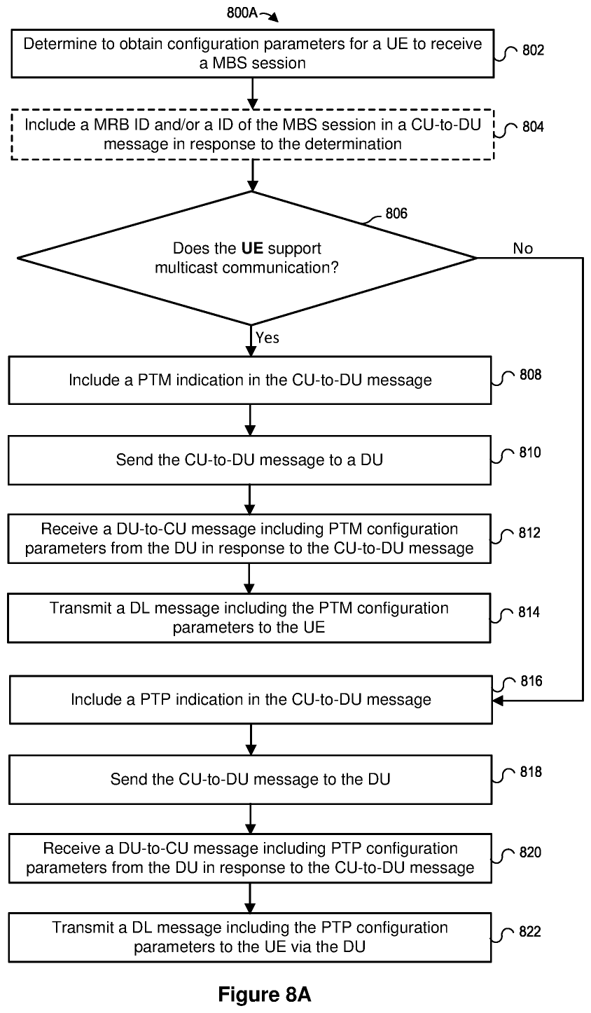

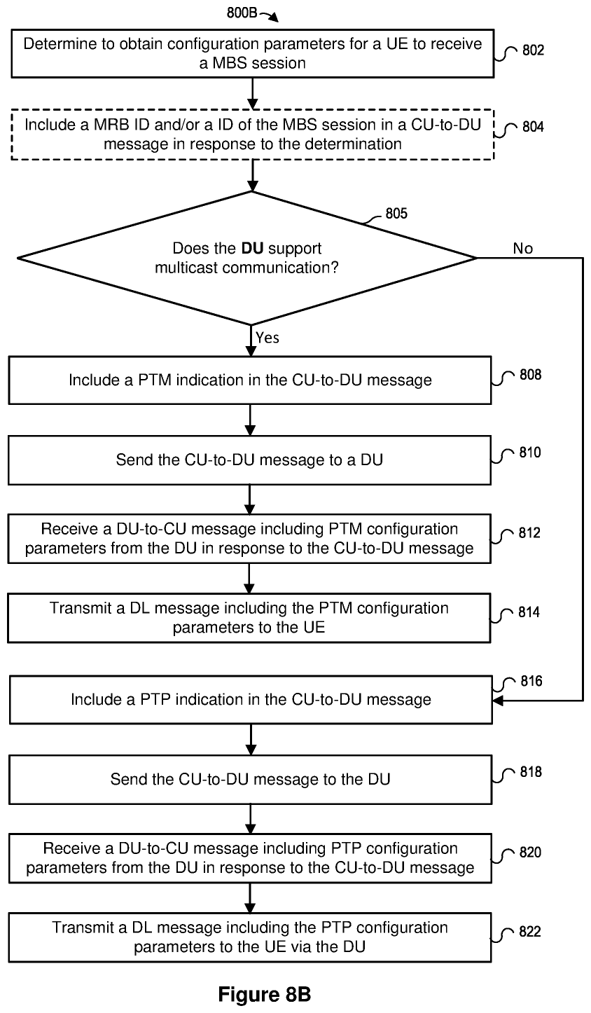

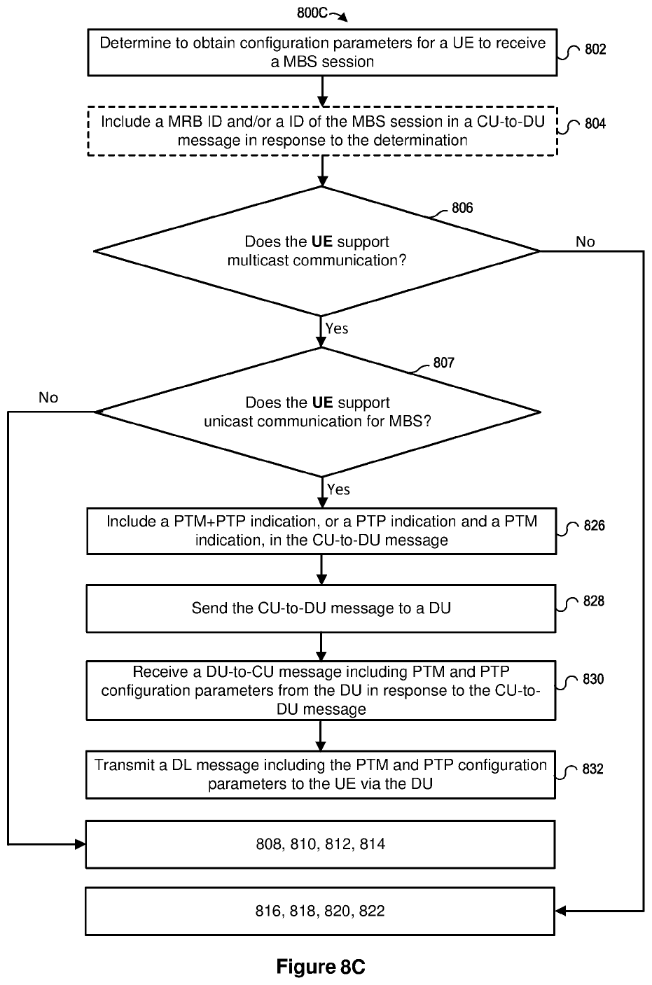

FIG. 8A is a flow diagram of an example method 800A in a CU for determining whether to cause the DU to request PTM or PTP configuration for a UE, depending on whether the UE supports multicast communications.

In some implementations, the CU can receive from a CN a CN-to-BS message (e.g., events 504, 512) indicating the UE joins the MBS session. In response to the CN-to-BS message, the CU determines to obtain configuration parameters for a UE to receive the MBS session.

In some implementations, the PTM configuration parameters includes a G-RNTI, at least one first logical channel ID, at least one RLC configuration parameter, at least one first RLC bearer configuration, at least one first RLC configuration and/or a RLC mode (e.g., unacknowledged mode). In some implementations, the PTP configuration parameters includes at least one second logical channel ID, at least one second RLC configuration parameter, at least one second RLC bearer configuration, at least one second RLC configuration and/or a RLC mode (e.g., acknowledged mode).

In some implementations, the PTM configuration parameters include physical layer configuration parameters and/or MAC layer configuration parameters. In some implementations, the physical layer configuration parameters include BWP configuration parameters, common frequency range configuration parameters, PDCCH configuration parameters, HARQ configuration parameters and/or PDSCH configuration parameters.

After transmitting the PTP configuration parameters to the UE, the CU receives MBS data of the MBS session and transmits the MBS data to the DU via UE-specific tunnel(s), which in turn transmits the MBS data to the UE using the PTP configuration parameters.

FIG. 8B is a flow diagram of an example method 800B in a CU for determining whether to cause the DU to request PTM or PTP configuration for a UE, depending on whether the DU supports multicast communications. FIG. 8C is a flow diagram of an example method 800C in a CU for determining whether to cause the DU to request PTM or PTP configuration for a UE, depending on whether the UE supports multicast communications for MBS.

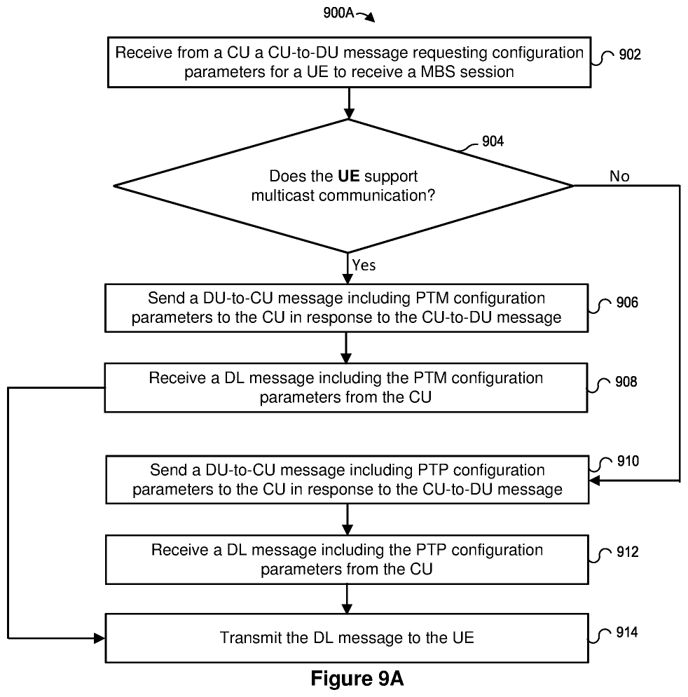

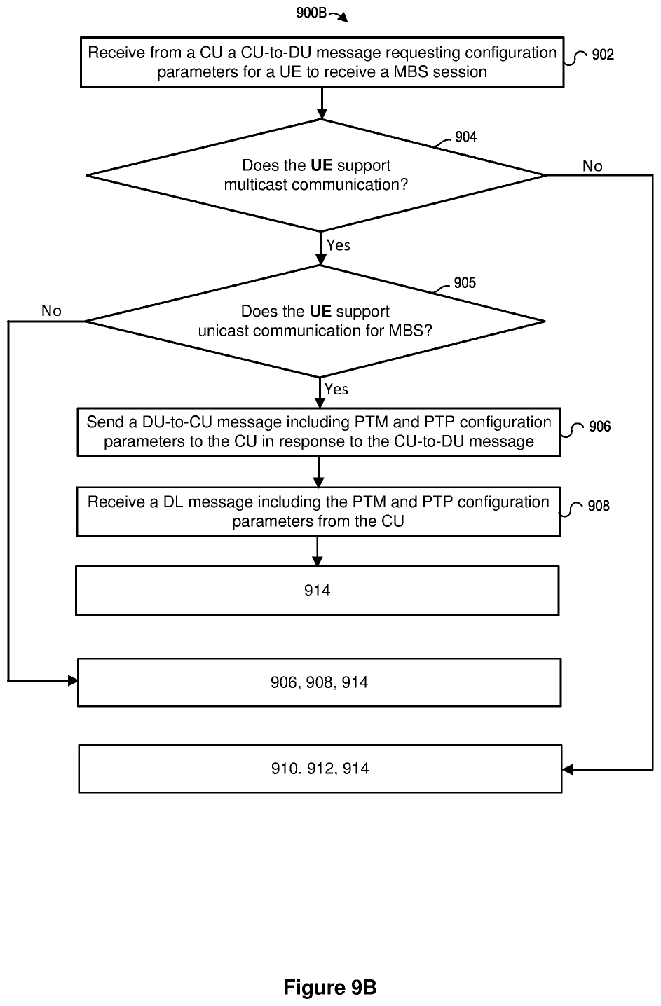

FIG. 9A is a flow diagram of an example method 900A in a DU for determining whether to generate a PTP or PTM configuration for a UE, depending on whether the UE supports multicast communications. FIG. 9B is a flow diagram of an example method 900B in a DU for determining whether to generate a PTP or PTM configuration for a UE, depending on whether the UE supports multicast communications for MBS;

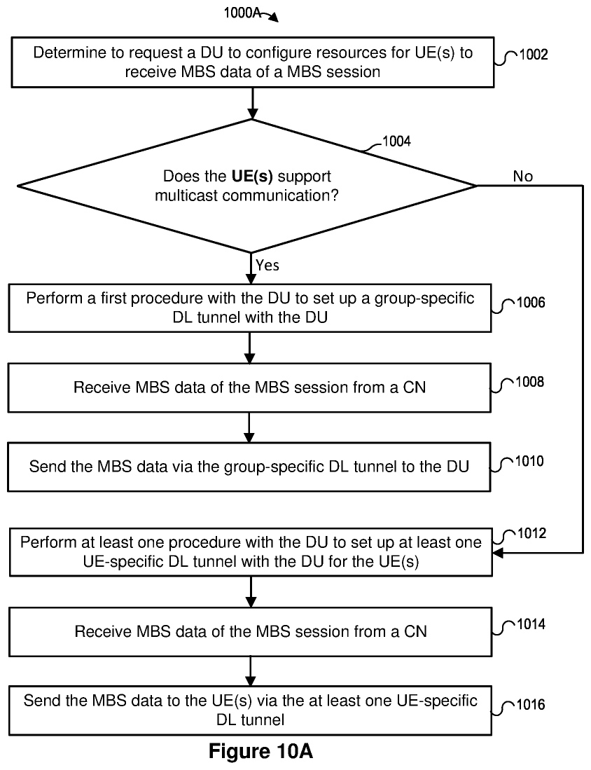

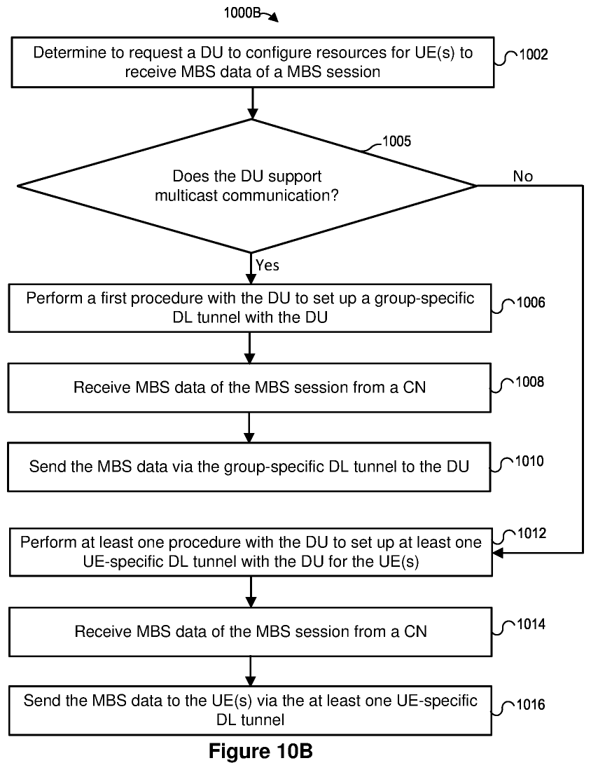

FIG. 10A is a flow diagram of an example method 1000A in a CU for determining whether to configure a group-specific or one or more UE-specific tunnels, depending on whether the UE(s) support multicast communications. FIG. 10B is a flow diagram of an example method 1000B in a CU for determining whether to configure a group-specific or one or more UE-specific tunnels, depending on whether the DU supports multicast communications.

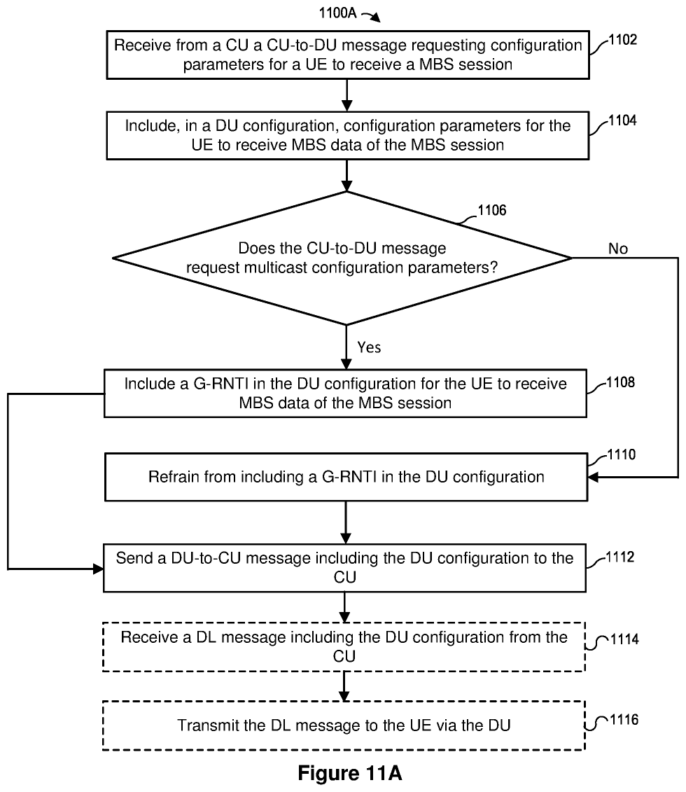

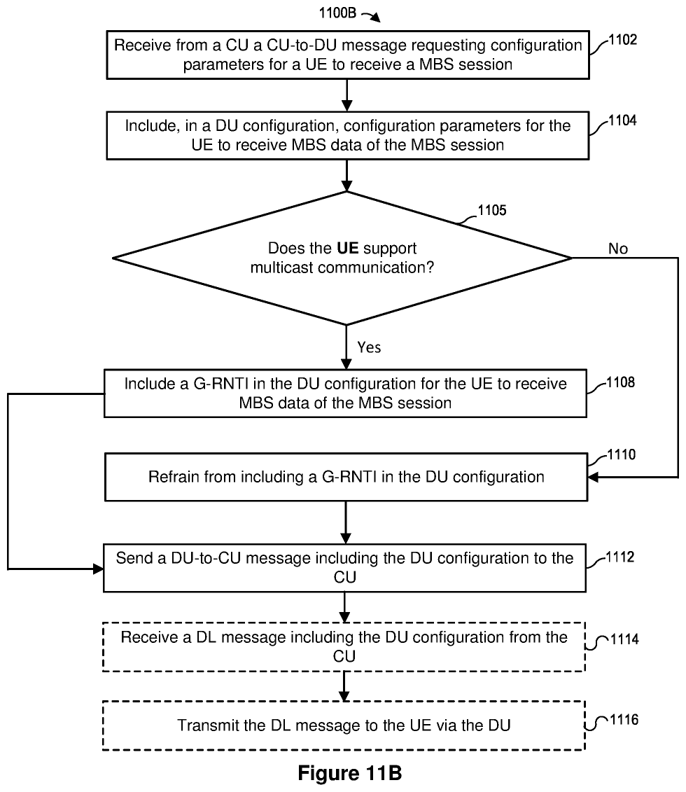

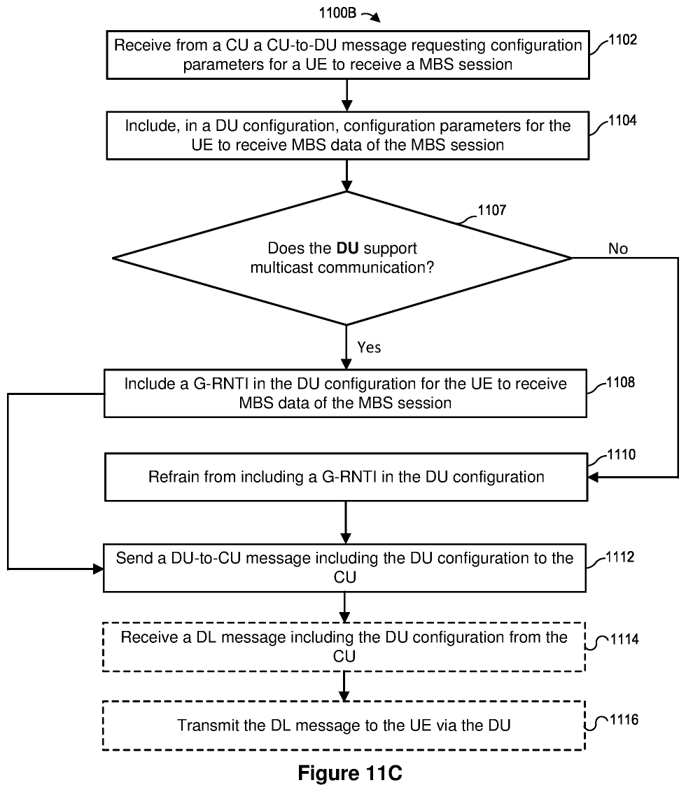

FIG. 11A is a flow diagram of an example method 1100A in a DU for determining whether to include a group identifier such as a G-RNTI in a DU configuration, depending on whether the CU requested multicast configuration parameters for an MBS session.

In some implementations, the configuration parameters can be common for receiving MBS data of the MBS session via multicast and unicast. For example, the configuration parameters include at least one RLC configuration parameter, at least one RLC bearer configuration (e.g., RLC-BearerConfig IE), at least one logical channel ID, at least one RLC configuration, and/or a RLC mode (e.g., unacknowledged mode).

In some implementations, the DU configuration can be a CellGroupConfig IE. In other implementations, the DU configuration can be a new IE. In some implementations, the DU can include the G-RNTI in a physical layer configuration (e.g., PhysicalCellGroupConfig IE) in the DU configuration. In other implementations, the DU can include the G-RNTI in a MAC configuration (e.g., MAC-CellGroupConfig IE). In yet other implementations, the DU can include the G-RNTI in the RLC bearer configuration.

In some implementations, the DU can include a C-RNTI in the DU configuration irrespective of whether the CU-to-DU message requests multicast configuration parameters. For example, the DU can include the C-RNTI in the physical layer configuration.

FIG. 11B is a flow diagram of an example method 1100B in a DU for determining whether to include a group identifier such as a G-RNTI in a DU configuration related to a UE, depending on whether the UE supports multicast configuration. FIG. 11C is a flow diagram of an example method 1100C in a DU for determining whether to include a group identifier such as a G-RNTI in a DU configuration, depending on whether the DU supports multicast communications.

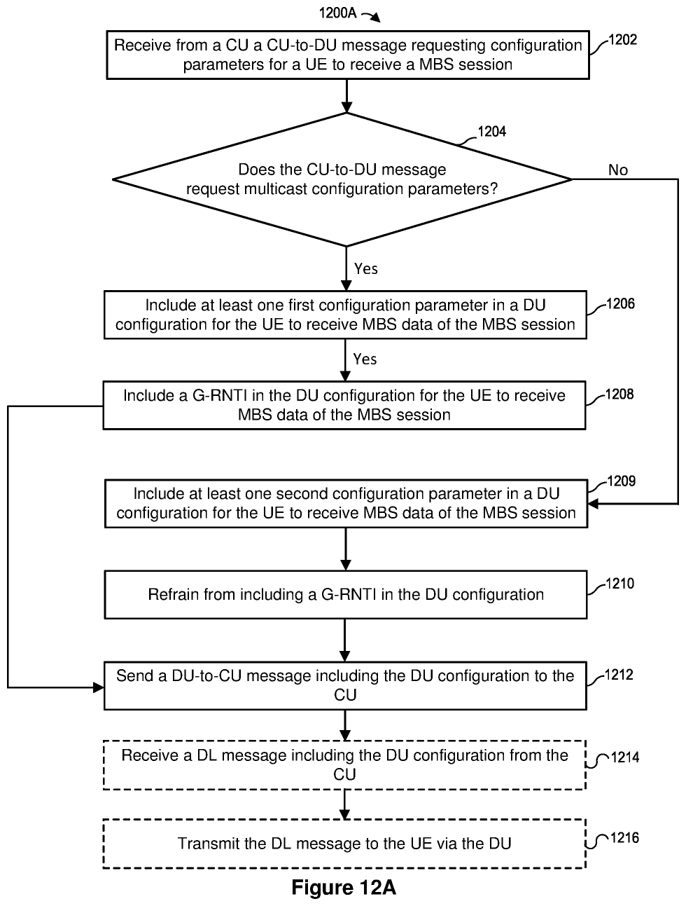

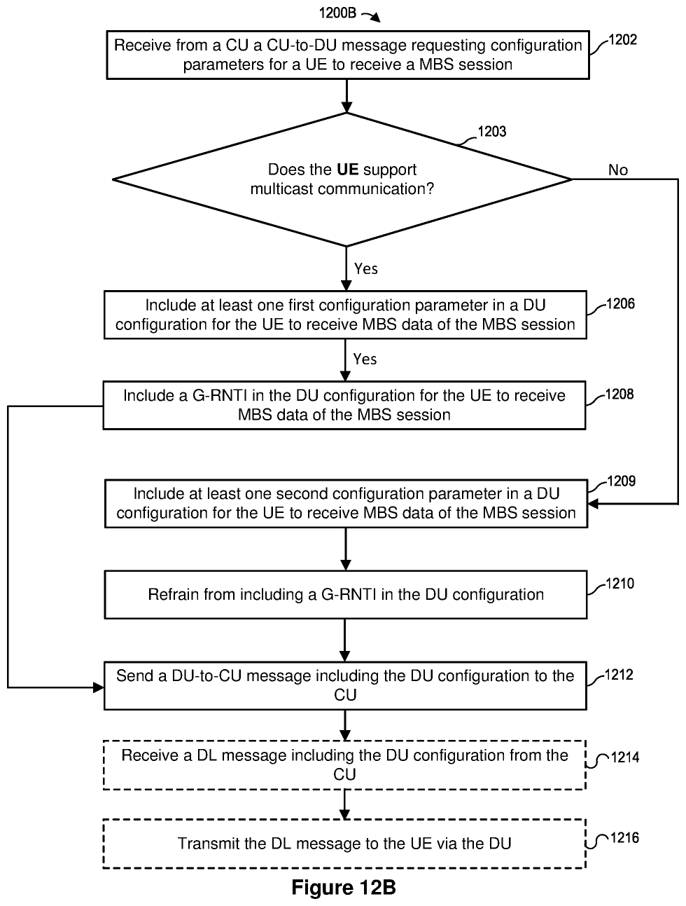

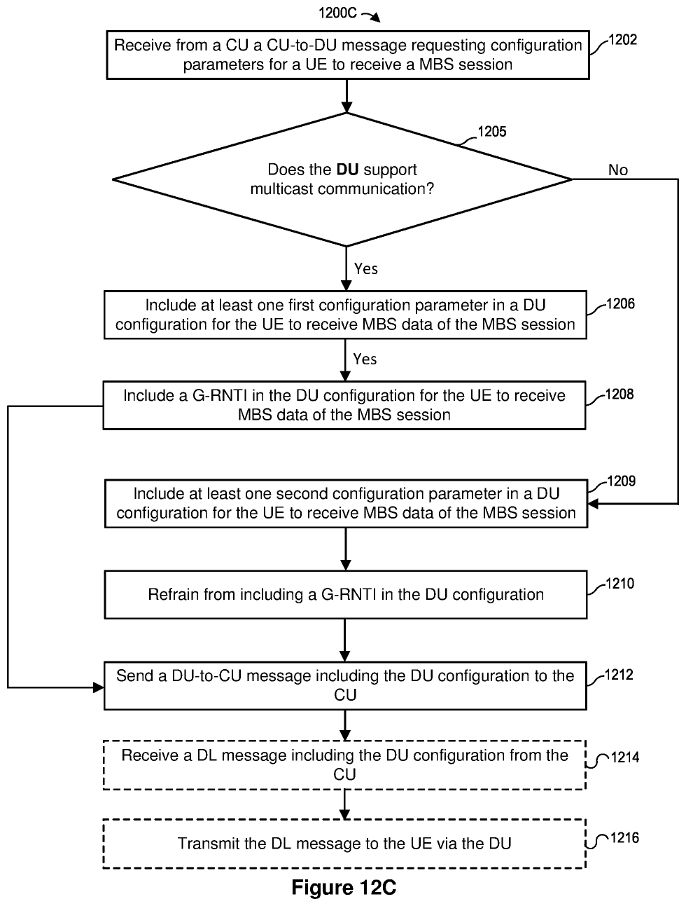

FIG. 12A is a flow diagram of an example method 1200A in a DU for determining whether to include a G-RNTI or a unicast configuration in a DU configuration, depending on whether the CU requested multicast configuration parameters for an MBS session. In some implementations, the at least one first configuration parameter includes a first logical channel ID and the at least one second parameter includes a second logical channel ID. In other implementations, the at least one first configuration parameter includes at least one RLC configuration parameter, at least one first RLC bearer configuration, at least one first RLC configuration and/or a RLC mode (e.g., unacknowledged mode). Similarly, the at least one second configuration parameter includes at least one second RLC configuration parameter, at least one second RLC bearer configuration, at least one second RLC configuration and/or a RLC mode (e.g., acknowledged mode).

FIG. 12B is a flow diagram of an example method 1200B in a DU for determining whether to include a G-RNTI or a unicast configuration in a DU configuration related to a UE, depending on whether the UE supports multicast configuration. FIG. 12C is a flow diagram of an example method 1200C in a DU for determining whether to include a G-RNTI or a unicast configuration in a DU configuration related to a UE, depending on whether the DU supports multicast communications.

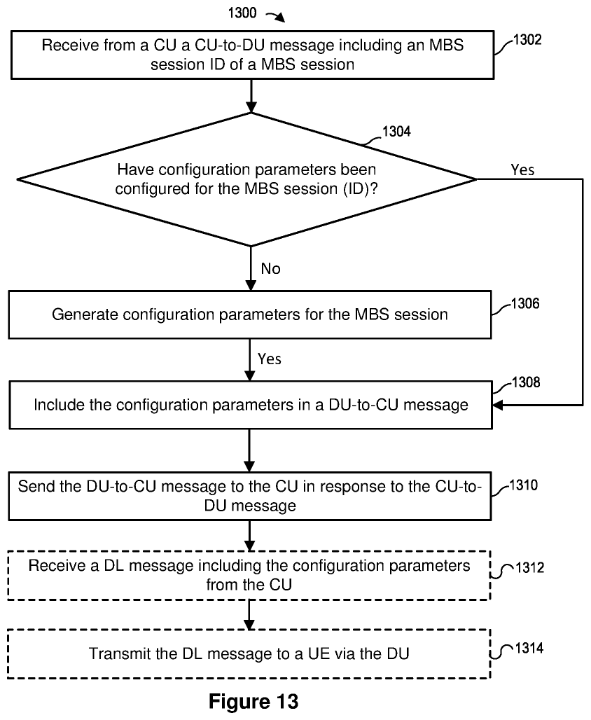

FIG. 13 is a flow diagram of an example method 1300 in a DU for determining whether the DU should generate a configuration for an MBS session, depending on whether the DU previously configured the MBS session. In some implementations, the configuration parameters can be PTM configuration parameters as described for FIG. 8A. In other implementations, the configuration parameters can be PTP configuration parameters as described for FIG. 8A.

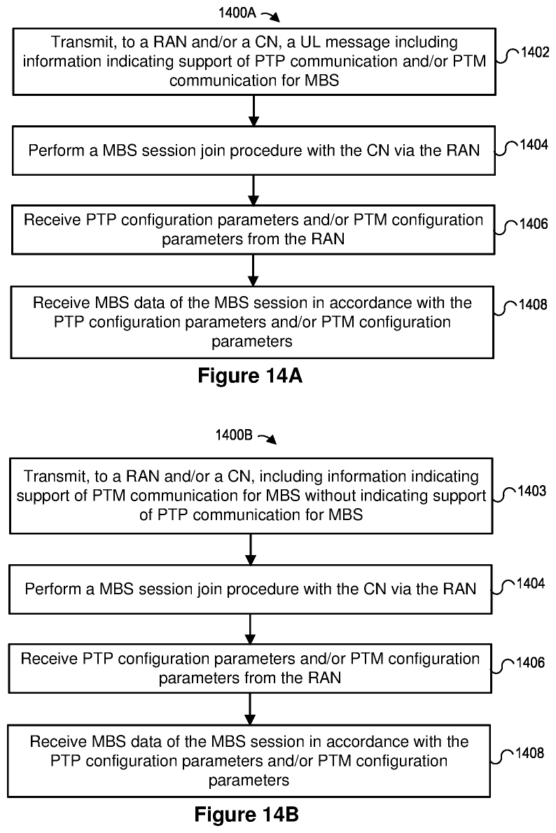

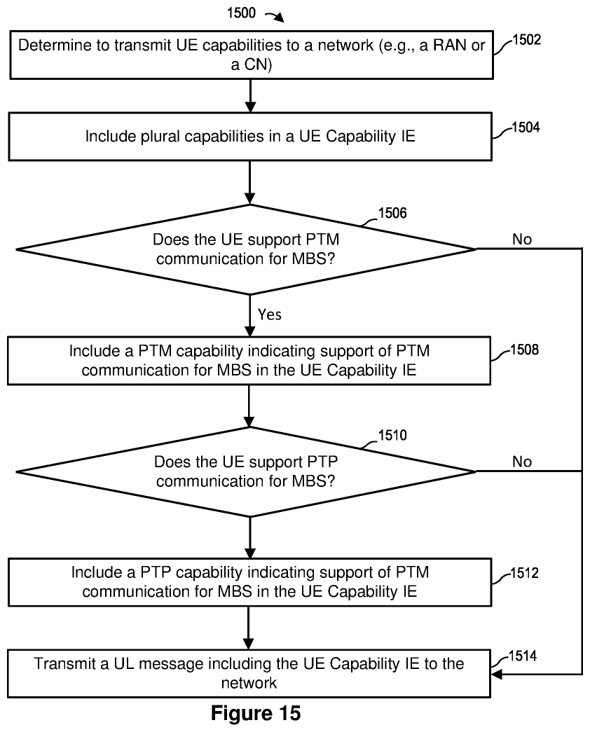

FIG. 14A is a flow diagram of an example method 1400A in a UE for configuring PTP reception of MBS data. FIG. 14B is a flow diagram of an example method 1400B in a UE for configuring PTP reception of MBS data, without explicitly indicating PTP support to the RAN. In some implementations, the UL message can be a UECapabilityInformation message. In other implementations, the UL message can be a NAS message. For example, the NAS message can be a 5GMM message or a 5GSM message specified in 3GPP specification 24.501. In another example, the NAS message can be a Registration Request message or a Registration Complete message. In some implementations, the information can be a UE radio capability ID IE. In some implementations, the information can be a UE-NR-Capability IE. In other implementations, the information can be a UE-6G-Capability IE.

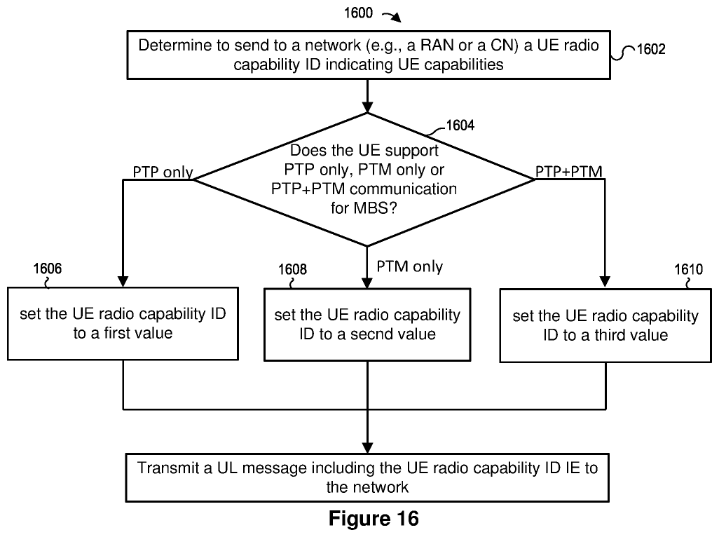

FIG. 15 is a flow diagram of an example method 1500A in a UE for indicating capabilities related to MBS, to the RAN and/or the CN. FIG. 16 is a flow diagram of an example method 1600 in a UE for determining how the UE should report multicast and unicast capabilities to the RAN and/or the CN.

The following list of examples reflects a variety of the embodiments explicitly contemplated by the present disclosure:

Example 1. A method for managing transmission of multicast and/or broadcast services (MBS), implemented in a central unit (CU) of a distributed base station that includes the CU and a distributed unit (DU), the method comprising: receiving, by processing hardware from a core network (CN), a request to configure resources for transmitting downlink (DL) MBS data associated with an MBS session; determining, based at least one of (i) a capability of the DU or (ii) a capability of a UE that joined the MBS session, whether the DU should transmit the MBS data to the UE over at least one of a radio interface using a point-to-point (PTP) or a point-to-multipoint (PTM) delivery mechanism; and causing the DU to transmit the MBS data in accordance with the determined delivery mechanism.

Example 2. The method of example 1, further comprising: transmitting the MBS data to the DU via a DL tunnel specific to the UE, the DL tunnel operating at a transport layer of a CU-to-DU link.

Example 3. The method of example 1, further comprising: transmitting the MBS data to the DU via a DL tunnel common to a group including the UE and least one other UE, the DL tunnel operating at a transport layer of a CU-to-DU link.

Example 4. The method of example 1, wherein causing the DU to transmit the MBS data to the UE includes: causing the DU to transmit an MBS data packet included in the MBS data to the UE using the PTM delivery mechanism; and causing the DU to re-transmit the MBS data packet to the UE using the PTP delivery mechanism, if the DU detects a failure to deliver the MBS data to the UE using the PTM delivery mechanism.

Example 5. The method of any of the preceding examples, wherein the determining is based at least in part on whether the DU supports multicast communications.

Example 6. The method of any of the preceding examples, wherein the determining is based at least in part on whether the UE supports multicast communications for MBS.

Example 7. The method of any of the preceding examples, wherein the determining is based at least in part on whether the DU supports multicast communications.

Example 8. A CU of a distributed base station comprising processing hardware and configured to implement any of the examples above.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein.

1-6. (canceled)

7. A method for managing transmission of multicast and/or broadcast services (MBS), implemented in a distributed unit (DU) of a distributed base station that includes the DU and a central unit (CU), the method comprising:
receiving, by the DU from a CU, a CU-to-DU message requesting configuration parameters for a user equipment (UE) to utilize to receive downlink (DL) MBS data associated with an MBS session;
determining, by the DU, based on whether the UE supports multicast configuration, whether to include, in a DU configuration message for the UE to utilize to receive the DL MBS data from the DU, point-to-point (PTP) configuration parameters or point-to-multipoint (PTM) configuration parameters;
generating, by the DU, in accordance with the determining, the DU configuration message; and
transmitting, by the DU to the CU, the DU configuration message.

8. The method of claim 7, wherein the generating includes:
in response to determining that the UE supports multicast configuration, including the PTM configuration parameters in the DU configuration message.

9. The method of claim 7, wherein the generating includes:
in response to determining that the UE does not support multicast configuration, including the PTP configuration parameters in the DU configuration message.

10. The method of claim 7, further comprising:
receiving, by the DU from the CU, a message including the DU configuration message from the CU; and
transmitting, by the DU to the UE, the message.

11. (canceled)

12. A method for managing transmission of multicast and/or broadcast services (MBS), implemented in a user equipment (UE), the method comprising:
transmitting, by the UE to a radio access network (RAN) node, an uplink message including information indicating UE support for at least one of point-to-point (PTP) communication or point-to-multipoint (PTM) communication for MBS;
receiving, by the UE from the RAN node, at least one of PTP configuration parameters or PTM configuration parameters based on the information included in the uplink message; and
receiving, by the UE, MBS data for an MBS session in accordance with the at least one of the PTP configuration parameters or the PTM configuration parameters.

13. The method of claim 12, wherein the information indicating the UE support for the at least one of the PTP communication or the PTM communication indicates the UE support for the PTM communication and refrains from indicating the UE support for the PTP communication.

14. The method of claim 13, wherein receiving the at least one of the PTP configuration parameters or the PTM configuration parameters includes:
receiving the PTM configuration parameters; and
refraining from receiving the PTP configuration parameters.

15. The method of claim 14, wherein the receiving the MBS data for the MBS session is in accordance with the PTM configuration parameters.

16. The method of claim 12, wherein the information indicating the UE support for the at least one of the PTP communication or the PTM communication indicates the UE support for the PTM communication and the UE support for the PTP communication.

17. The method of claim 16, wherein receiving the at least one of the PTP configuration parameters or the PTM configuration parameters includes:
receiving the PTP configuration parameters; and
receiving the PTM configuration parameters.

18. The method of claim 17, wherein the receiving the MBS data for the MBS session is in accordance with the PTP configuration parameters and the PTM configuration parameters.

19. The method of claim 12, further comprising:
performing, by the UE with a core network (CN) via the RAN node, an MBS session join procedure for the MBS session after transmitting the uplink message.

20. An apparatus, operating as a user equipment (UE), configured to manage transmission of multicast and/or broadcast services (MBS), the apparatus comprising:
a transceiver; and
processing hardware configured to:
transmit, to a radio access network (RAN) node, an uplink message including information indicating UE support for at least one of point-to-point (PTP) communication or point-to-multipoint (PTM) communication for MBS;
receive, from the RAN node, at least one of PTP configuration parameters or PTM configuration parameters based on the information included in the uplink message; and
receive MBS data for an MBS session in accordance with the at least one of the PTP configuration parameters or the PTM configuration parameters.

21. The apparatus of claim 20, wherein the information indicating the UE support for the at least one of the PTP communication or the PTM communication indicates the UE support for the PTM communication and refrains from indicating the UE support for the PTP communication.

22. The apparatus of claim 21, wherein receiving the at least one of the PTP configuration parameters or the PTM configuration parameters includes:
receiving the PTM configuration parameters; and
refraining from receiving the PTP configuration parameters.

23. The apparatus of claim 22, wherein receiving the MBS data for the MBS session is in accordance with the PTM configuration parameters.

24. The apparatus of claim 20, wherein the information indicating the UE support for the at least one of the PTP communication or the PTM communication indicates the UE support for the PTM communication and the UE support for the PTP communication.

25. The apparatus of claim 24, wherein receiving the at least one of the PTP configuration parameters or the PTM configuration parameters includes:
receiving the PTP configuration parameters; and
receiving the PTM configuration parameters.

26. The apparatus of claim 25, wherein receiving the MBS data for the MBS session is in accordance with the PTP configuration parameters and the PTM configuration parameters.

27. The apparatus of claim 20, wherein the processing hardware is further configured to:
perform, with a core network (CN) via the RAN node, an MBS session join procedure for the MBS session after transmitting the uplink message.
